(19) United States
(12) Patent Application Publication
(10) Pub. No.: US 2018/0197643 A1
(43) Pub. Date: Jul. 12, 2018

(54) Monitoring and Controlling Exothermic Reactions Using Photon Detection Devices

(71) Applicant: Industrial Heat, LLC, Raleigh, NC (US)

(72) Inventors: Julie A. Morris, Flower Mound, TX (US); Joseph A. Murray, Raleigh, NC (US)

(21) Appl. No.: 15/795,171

(22) Filed: Oct. 26, 2017

Related U.S. Application Data
(60) Provisional application No. 62/412,941, filed on Oct. 26, 2016.

(51) Int. Cl. G21C 17/08; G21D 3/04; H05H 6/00; G21B 3/00

(52) U.S. Cl. CPC G21C 17/08; G21B 3/00; H05H 6/00; G21D 3/04

(57) ABSTRACT

A method includes vacuuming an environment containing a low energy nuclear reaction (LENR) system and flowing a gaseous material into the environment. The method includes heating the reactor to a first temperature range and applying a voltage to an electrode passing through a core of the LENR system. The method includes imaging one of the core or the system with a spectrometer and determining that the core is at a desired temperature based on the imaging.

### CROSS-REFERENCE TO RELATED APPLICATIONS

This application claims priority to U.S. Provisional Patent Application No. 62/412,941 filed on Oct. 26, 2016 and entitled “Monitoring and Controlling Exothermic Reactions Using Photon Detection Devices,” the contents of which are incorporated herein by reference.

### BACKGROUND

### Field of the Invention

The present disclosure relates to monitoring and controlling exothermic reactions. More specially, this disclosure describes an exothermic reactor in which initiating plasma is one potential method to activate the exothermic reaction system. A well-defined, objective and quantifiable method is needed to determine the state of the plasma.

### Description of Related Art

Many types of reactors have been built and tested to create exothermic reactions. These reactors range from wet cells using electrolysis to solid state reactors to plasma reactors. Each reactor type requires specific materials, activation procedures, and triggering methods. This disclosure focuses on the plasma reactor system, more specifically for the plasma reactor system.

In order to activate the plasma reactor, a plasma that emits light is generated in a reactor. The color of the plasma is dependent on the type of gas inside the reaction chamber. The color of the plasma, and therefore the type of gas inside the reaction chamber, tells the state of activation and whether the activation process needs to continue or if it is complete. Sparks and arcs can also be monitored to know what state the plasma is in, for example, sparking mode, arcing mode, glow discharge mode, etc.

Devices, generally referred to as spectrometers or optical spectrometers, already exist to monitor wavelength emissions in various ranges, including but not limited to infrared, visible/color, UV, and others. Spectrometers measure the intensity of light based on wavelength and frequency.

Although spectrometers are very well known and understood, they have not been used to monitor the activation process of preparing an exothermic reaction system.

### BRIEF SUMMARY

According to one embodiment of the present invention, a method includes vacuuming an environment containing a low energy nuclear reaction (LENR) system and flowing a gaseous material into the environment. The method includes heating the reactor to a first temperature range and applying a voltage to an electrode passing through a core of the LENR system. The method includes imaging one of the core or the system with a spectrometer and determining that the core is at a desired temperature based on the imaging.

According to one or more embodiments, determining that the core is at a desired temperature includes detecting a first intensity peak occurring at a first wavelength and detecting a second intensity peak occurring at a second wavelength.

According to one or more embodiments, when a first intensity peak and a second intensity peak is not detected, the method further including increasing the voltage to the electrode.

According to one or more embodiments, the first wavelength is about 400 to about 450 nm.

According to one or more embodiments, the second wavelength is about 550 to about 625 nm.

According to one or more embodiments, the intensity peaks are relative intensities.

According to one or more embodiments, the applied voltage is between about 200 volts and about 1200 volts.

According to one or more embodiments, the vacuum is a minimum of 10̂-3 torr.

According to one or more embodiments, the flow of gaseous material is between 1 and 10 Pa.

According to one or more embodiments, the flow of gaseous material is between 1 and 3 Pa.

According to one or more embodiments, the heating is between about 100 degrees C. and about 400 degrees C.

According to one or more embodiments, an energy production system includes a low energy nuclear reaction (LENR) device and a spectrometer configured to image the LENR device. The system includes a control device configured for causing vacuuming an environment containing the LENR device, flowing a gaseous material into the environment, heating the reactor to a first temperature range, applying a voltage to an electrode passing through a core of the LENR device, imaging one of the core or the system with the spectrometer, and determining that the core is at a desired temperature based on the imaging.

### BRIEF DESCRIPTION OF THE SEVERAL VIEWS OF THE DRAWINGS

FIG. 1 illustrates an energy production system according to one or more embodiments disclosed herein;

FIG. 2 illustrates an energy production system according to one or more embodiments disclosed herein;

FIG. 3 illustrates a flow chart depicting one or more methods disclosed herein;

FIG. 4 illustrates a diagram of intensity versus wavelength according to one more embodiments disclosed herein;

FIG. 5 illustrates a diagram of intensity versus wavelength according to one or more embodiments disclosed herein; and

FIG. 6 illustrates a flow chart depicting one or more methods disclosed herein.

### DETAILED DESCRIPTION

When conducting an LENR energy harvesting experiment or exercise, one must monitor the color of the LENR core to determine an optimum efficiency and/or temperature range. On some reactors, a window is used so that the operator can monitor the color of the plasma during activation by sight. When the color appears pink, then the operator allows the activation to continue. When the color appears blue, then the operator stops activation.

There are three main problems using the human eye method:

(1) The window itself has the potential to affect the color. For example, if a sapphire window is used instead of a clear window, then the color of the plasma could be altered.
(2) The window often has a temperature limit associated with it, which could cause limitations on the reactor. For example, if the reactor needs to reach a high temperature and remain at vacuum pressures, then the window may be a limiting factor, or extra expense may need to be added to the reactor so that the window is not around conditions that it is not rated for.
(3) Colors look different to different people. People also have color blindness. So, a pink plasma to one person could look like a different color to another person. Therefore, knowing what state the plasma in could be very subjective and cause bad activations.

Disclosed herein is a method of using a photon detection device to monitor the state of the plasma during the activation process of preparing an exothermic reaction system. A photon detection device may refer to a range of devices that can detect a range of wavelengths. For example, a photon detection device may be a UV photon detector that can be configured to detect photons in the UV spectrum range. A photon detection device may be a spectrometer device, e.g., an optical spectrometer that can be configured to detect visible lights. Used in conjunction with an exothermic reactor, an optical spectrometer is able to more accurately and more consistently tell the intensity of all wavelengths of light being emitted from the glow discharge taking place in the exothermic reactor. This allows for better classification of exact color of the plasma, and thus allows the operator to better determine what state the activation process is in.

Examples of a photon detection device may also include gamma detector. A gamma detector detects gamma ray emissions, which may indicate the stage or status of an exothermic reaction. Technically, neutrons are not photons and a photon detection device does not normally include a neutron detector. However, similar to a photon detection device, a neutron detector can be used to monitor and control the LENR process.

Since the device is not subjective, like a human eye, determining the true color being emitted becomes quantifiable. It also becomes consistent across different reactors. A person may think they see violet instead of blue, all very subjective terms. However, the spectrometer allows the state of the glow discharge to be quantified into known intensity levels at known wavelength ranges. Therefore, reactors can be activated more consistently since the parameters governing activation become quantifiable, measurable values.

Eventually, the spectrometer can be used to automate control of activation, knowing when and how much voltage to apply, and when to remove voltage and call the activation procedure complete.

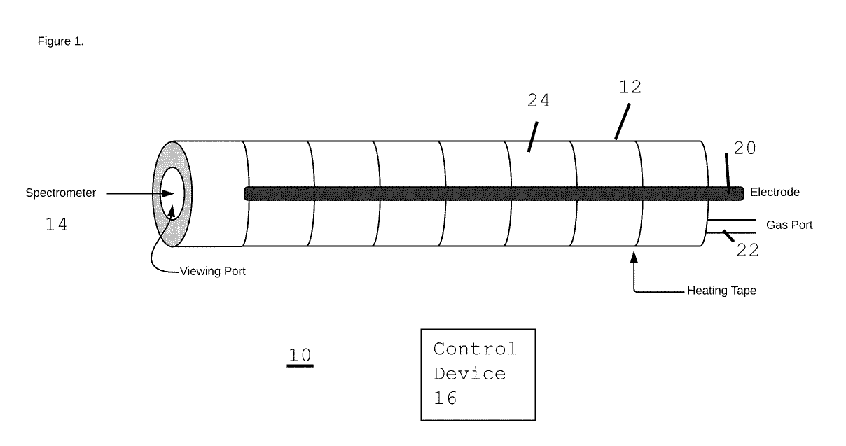

FIG. 1 illustrates one reactor system, namely an energy production system 10. A high voltage electrode 20 runs down the center of a cylindrical reactor container 12. One or more gas ports 22 are available to flow gas into the reactor and/or to pull a vacuum. Heating tape 24 is wrapped around the vessel so that it can be heated to the desired temperature. A viewing port is on the reactor so that the electrode and body is visible. The plasma will be generated due to the voltage differential from the electrode to the body, so this is the area where the glow must be monitored. The viewing port can be large enough so that a human operator can see inside the reactor, or it can be only large enough for the spectrometer viewing area to be able to see the inside of the reactor. A control device 16 may be provided for carrying out the one or more methods disclosed herein.

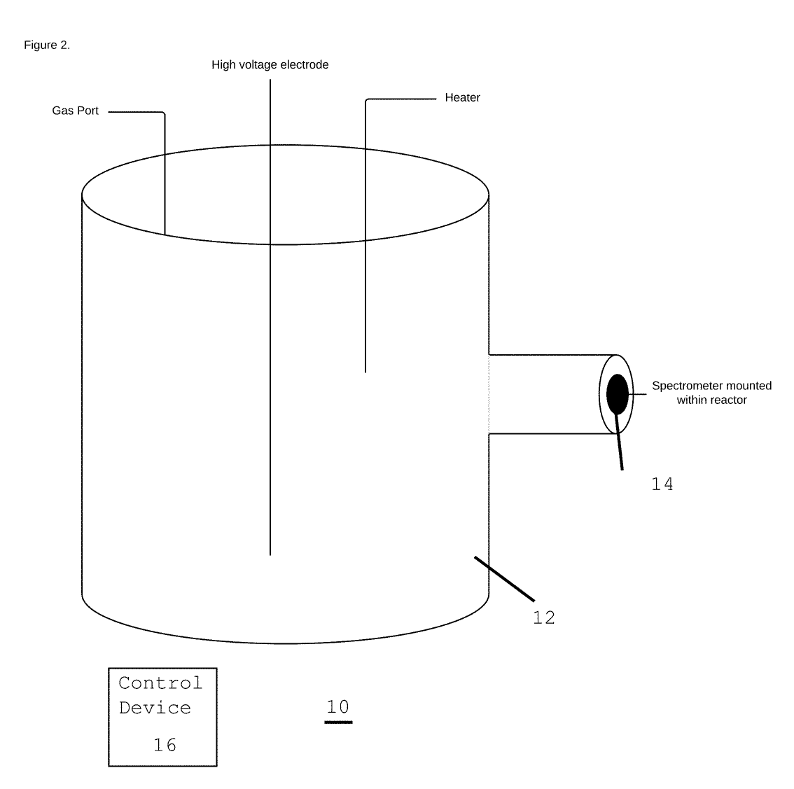

FIG. 2 illustrates an energy production system 10 including an LENR device 12. In this embodiment, there is no viewing port. The spectrometer 14 is mounted within the reactor body. Care is taken so that the spectrometer temperature and pressure ratings are not violated, so it may need to be mounted at a point further away from the main inside reactor body where the plasma will be generated. A control device 16 may be provided for carrying out the one or more methods disclosed herein. The control device 16 may include a memory and a processor and be configured for directing one or more computers, or one or more personnel. The control device 16 may communicate over a wired or wireless network.

Since there are several manufacturers that make spectrometers, and many various models, the details of mounting are not shown in this embodiment. An advantageous aspect is that the window of the spectrometer is able to see the inside of the reactor.

In this reactor embodiment, a high voltage electrode 20 runs down the center of the main reactor body. At least one gas port is available to flow gas in and/or pull vacuum. A heater cartridge is on the inside of the reactor to provide heat to reach the desired temperatures. A side piece juts out from the main reactor so that the spectrometer can still have a view of the plasma-generation area while being kept away from the main source of heat.

The reactor remains in the “in progress” state until the two desired peaks listed previously disappear. The activation procedure is considered done once the spectrometer shows a peak wavelength intensity in the about 455 to about 500 nm range, typically resulting in a blue glow to the human eye.

Spectrometers can typically see all visible light ranging from approximately 390 nm to 700 nm. Some spectrometers can see into UV, infrared, and other non-visible wavelength light.

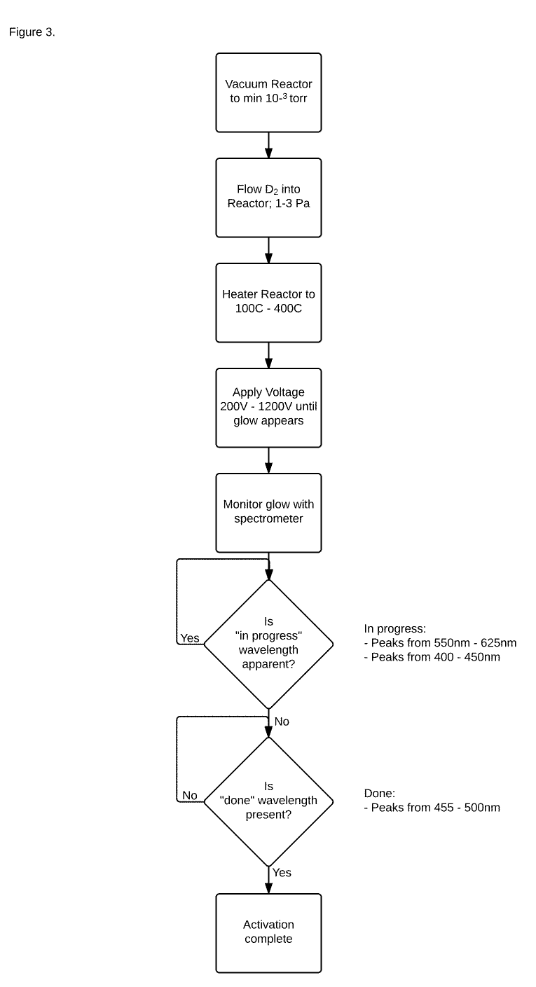

FIG. 3 illustrates an example method according to one or more embodiments disclosed herein to activate the plasma reactor and monitor with a spectrometer.

The reactor is first vacuumed to a minimum of 10̂-3 torr vacuum. Deuterium is then flowed into the reactor to a pressure of 1-3 Pa. Heat is applied to the reactor until the inside of the reactor reaches a temperature from 100 C-400 C. While the reactor body is grounded, a high voltage AC or DC signal is applied to the middle electrode. The voltage signal can be 200V-1200V AC or DC until a flow discharge plasma begins and current flows from 20 mA-200 mA.

The plasma is considered at the “activation in progress” state while the spectrometer shows 2 relative peaks to other wavelength intensities. There should be a peak of wavelength intensity between 400-450 nm (typically resulting in a violet glow to the human eye). Another peak of wavelength intensity should be present between 550 nm-650 nm (typically resulting in a pink glow to the human eye). Pink is actually a combination of other color wavelengths, combining to form the subjective “pink” color.

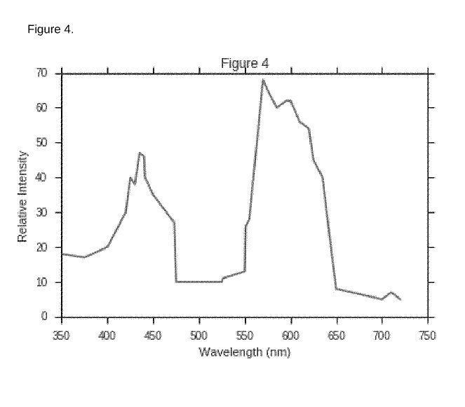

FIG. 4 illustrates an an example of the spectrometer output, which is a graph of relative light intensity versus wavelength. During the beginning of activation, since a violet-pink color is desired, there should be a higher intensity at wavelength range about 400 nm to about 450 nm and about 550 nm to about 650 nm. The about 400 nm to about 450 nm range results in a glow that typically appears violet to the human eye. Pink is a mixture of primary colors and thus has a larger wavelength range where peaks will appear in varying intensity between about 550 nm and about 650 nm.

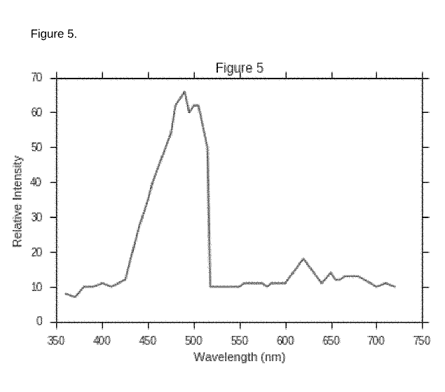

FIG. 5 illustrates an example of the spectrometer output, which is a graph of relative light intensity versus wavelength. Activation is considered complete when the peak has shifted to a peak around about 455 to about 500 nm. This range results in a glow that typically appears blue to the human eye.

If the viewing port is tinted, then the effect of the glass on the wavelength is taken into account when looking at the spectrometer output for any of the above figures. The above peak wavelength ranges are the desired ranges see at the inside of the reactor.

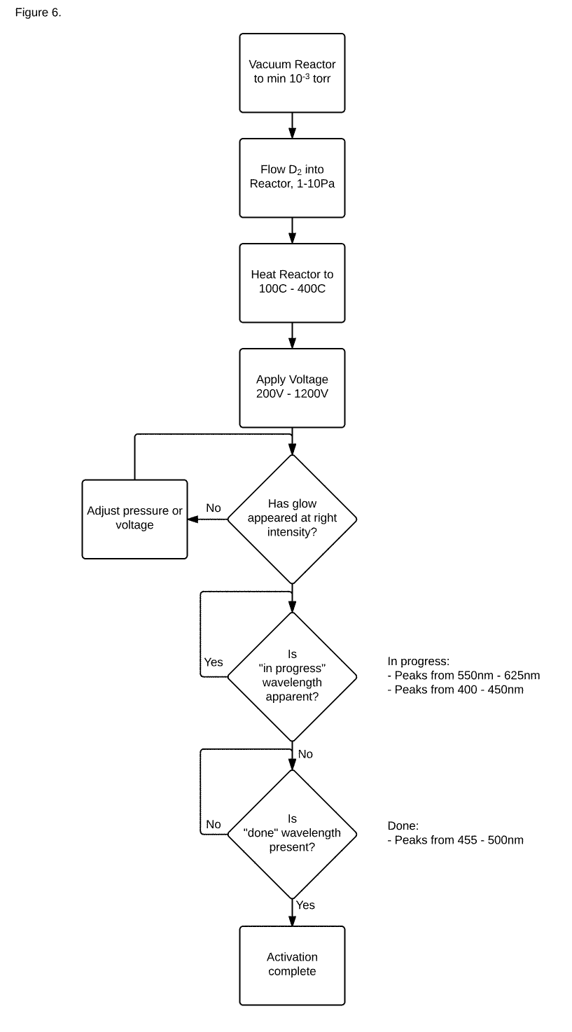

FIG. 6 illustrates an example method according to one or more embodiments disclosed herein. This figure provides an example embodiment of the procedure used to activate the plasma reactor and monitor and control with a spectrometer.

The reactor is first vacuumed to a minimum of 10̂-3 torr vacuum. Deuterium is then flowed into the reactor to a pressure of about 1 to about 10 Pa. Heat is applied to the reactor until the inside of the reactor reaches a temperature from about 100 C to about 400 C. While the reactor body is grounded, a high voltage AC or DC signal is applied to the middle electrode. The voltage signal can be about 200V to about 1200V AC or DC.

The spectrometer is used to determine the state of the plasma. If the plasma is in the desired range, then go to the next step. If the plasma is not in the desired range, then the pressure or voltage is adjusted until the desired plasma is created. This can be a glow discharge, arcing, sparking, or other plasma.

The plasma is considered at the “activation in progress” state while the spectrometer shows 2 relative peaks to other wavelength intensities. There should be a peak of wavelength intensity between about 400 and about 450 nm (typically resulting in a violet glow to the human eye). Another peak of wavelength intensity should be present between about 550 nm and about 650 nm (typically resulting in a pink glow to the human eye). Pink is actually a combination of other color wavelengths, combining to form the subjective “pink” color.

The reactor remains in the “in progress” state until the two desired peaks listed previously disappear. The activation procedure is considered done once the spectrometer shows a peak wavelength intensity in the about 455 and about 500 nm range, typically resulting in a blue glow to the human eye.

The spectrometer may be configured for determining other data points. For example, a color gradient may be indicative of a desired or undesired operation condition. If the color gradient is not consistent across the core or not consistent with an expected gradient across the core, this could be evidence of the core having a fuel shortage. The electrode could also be gridded throughout the core and could have electricity selectively applied to particular grids when appropriate. Additionally, due to aggregation of data across many different reactors, the life or burn rate of a core can be determined based on the measurements from the spectrometer. A temperature gauge may also be provided to coordinate and provide another degree of information and/or readings relative to the measurements form the spectrometer.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter situation scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed.

Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
vacuuming an environment containing a low energy nuclear reaction (LENR) system;
flowing a gaseous material into the environment;
heating the reactor to a first temperature range;
applying a voltage to an electrode passing through a core of the LENR system;
imaging one of the core or the system with a spectrometer; and
determining that the core is at a desired temperature based on the imaging.

2. The method according to claim 1, wherein determining that the core is at a desired temperature comprises:
detecting a first intensity peak occurring at a first wavelength; and
detecting a second intensity peak occurring at a second wavelength.

3. The method according to claim 2, wherein, when a first intensity peak and a second intensity peak is not detected, the method further including increasing the voltage to the electrode.

4. The method according to claim 2, wherein the first wavelength is about 400 to about 450 nm.

5. The method according to claim 2, wherein the second wavelength is about 550 to about 625 nm.

6. The method according to claim 1, wherein the intensity peaks are relative intensities.

7. The method according to claim 1, wherein the applied voltage is between about 200 volts and about 1200 volts.

8. The method according to claim 1, wherein the vacuum is a minimum of 10̂-3 torr.

9. The method according to claim 1, wherein the flow of gaseous material is between 1 and 10 Pa.

10. The method according to claim 1, wherein the flow of gaseous material is between 1 and 3 Pa.

11. The method according to claim 1, wherein the heating is between about 100 degrees C. and about 400 degrees C.

12. An energy production system comprising:
a low energy nuclear reaction (LENR) device;
a spectrometer configured to image the LENR device;
a control device configured for causing:
vacuuming an environment containing the LENR device;
flowing a gaseous material into the environment;
heating the reactor to a first temperature range;
applying a voltage to an electrode passing through a core of the LENR device;
imaging one of the core or the system with the spectrometer; and
determining that the core is at a desired temperature based on the imaging.

13. The energy producing system according to claim 12, wherein determining that the core is at a desired temperature comprises:
detecting a first intensity peak occurring at a first wavelength; and
detecting a second intensity peak occurring at a second wavelength.

14. The energy producing system according to claim 13, wherein, when a first intensity peak and a second intensity peak is not detected, the control device further configured for causing increasing the voltage to the electrode.

15. The energy producing system according to claim 13, wherein the first wavelength is about 400 to about 450 nm.

16. The energy producing system according to claim 13, wherein the second wavelength is about 550 to about 625 nm.

17. The energy producing system according to claim 13, wherein the intensity peaks are relative intensities.

18. The energy producing system according to claim 12, wherein the applied voltage is between about 200 volts and about 1200 volts.

19. The energy producing system according to claim 12, wherein the vacuum is a minimum of 10̂-3 torr.

20. The energy producing system according to claim 12, wherein the flow of gaseous material is between 1 and 10 Pa.

21. The energy producing system according to claim 12, wherein the flow of gaseous material is between 1 and 3 Pa.

22. The energy producing system according to claim 12, wherein the heating is between about 100 degrees C. and about 400 degrees C.
